(19) United States
(12) Patent Application Publication
(10) Pub. No.: US 2026/0280286 A1
(43) Pub. Date: Sep. 17, 2026

(54) DISTRIBUTED POWER SUPPLY INTEGRATED MANAGEMENT SYSTEM, DISTRIBUTED POWER SUPPLY INTEGRATED MANAGEMENT DEVICE, DISTRIBUTED POWER SUPPLY INTEGRATED MANAGEMENT METHOD, AND COMPUTER-READABLE NON-TRANSITORY STORAGE MEDIUM

(71) Applicant: Mitsubishi Electric Corporation, Chiyoda-ku, Tokyo (JP)

(72) Inventors: Keishi MATSUDA, Chiyoda-ku, Tokyo (JP); Yu KAWAI, Chiyoda-ku, Tokyo (JP); Shuto ISHIYAMA, Chiyoda-ku, Tokyo (JP); Sadayuki INOUE, Chiyoda-ku, Tokyo (JP); Rutvikanandan MANOHAR, Chiyoda-ku, Tokyo (JP); Koki MATSUMOTO, Chiyoda-ku, Tokyo (JP)

(73) Assignee: Mitsubishi Electric Corporation, Chiyoda-ku, Tokyo (JP)

(21) Appl. No.: 19/473,282

(22) PCT Filed: May 23, 2023
(86) PCT No.: PCT/JP2023/019068

§ 371 Date: Oct. 7, 2025

(51) Int. Cl. H02J 3/0014; H02J 3/11; H02J 3/32; H02J 3/38; H02J 3/46; H02J 101/20

(52) U.S. Cl. CPC H02J 3/00142; H02J 3/11; H02J 3/32; H02J 3/381; H02J 3/46; H02J 2101/20

(57) ABSTRACT

A plurality of distributed power supplies at least includes one voltage source type distributed power supply and one current source type distributed power supply. The voltage source type distributed power supply operates as a voltage source and has a first type drooping characteristic that is a drooping characteristic in which a voltage frequency changes according to output power. The current source type distributed power supply operates as a current source and has a second type drooping characteristic that is a drooping characteristic in which output power changes according to a voltage frequency. A drooping characteristic determinator determines control information that provides the second type drooping characteristic on the basis of the first type drooping characteristic in a control range of a common voltage frequency. A control information setter sets the control information in the current source type distributed power supply.

### TECHNICAL FIELD

The present disclosure relates to a distributed power supply integrated management system, a distributed power supply integrated management device, a distributed power supply integrated management method, and a computer-readable non-transitory storage medium.

### BACKGROUND ART

A power system that supplies AC (alternating current) power from a power supply to a load is controlled such that an output voltage and a voltage frequency are maintained regardless of a supply and demand situation. A method for controlling an output voltage and a voltage frequency in a power supply system including a plurality of distributed power supplies has been proposed.

For example, Patent Document 1 describes a power generation system that performs parallel operation of a constant voltage control type power generation device and a constant power control type power generation device without using an external control device, and a method for controlling the power generation system.

Patent Document 2 describes a power management system that ensures the same amount of power at the same time without excessively increasing a calculation load for creating an operation plan of a plurality of distributed power supplies and without unnecessarily suppressing an output of an energy creation device, during self-sustaining operation in case of suspension of a management section, where a plurality of distributed power supplies, including an energy generating device, are disposed.

In addition, when the magnitude of a load suddenly changes, an inertial force of power decreases, and a voltage and a frequency of AC power supplied from a power supply may change. Such a change tends to be more significant as the amount of AC power introduced from a non-rotator power supply or a renewable energy power supply increases. Examples of the non-rotator power supply or the renewable energy power supply include a storage battery, a solar panel, and a wind power generator. As a countermeasure against this, it has been proposed to cause an inverter attached to a power supply to execute pseudo inertia control to apply a pseudo inertial force. For example, Patent Document 3 describes an inverter control device, an inverter control program, and an inverter control method that cause a plurality of inverters having different ratios of output power to rated output power to stably operate.

### CITATION LIST

### Patent Document

### Patent Document 1

PCT International Publication No. WO 2019/239664

### Patent Document 2

Japanese Unexamined Patent Application, First Publication No. 2009-290939

### Patent Document 3

Japanese Unexamined Patent Application, First Publication No. 2020-198705

### SUMMARY OF INVENTION

### Technical Problem

The pseudo inertia control is classified into a voltage source type and a current source type. A distributed power supply capable of executing the voltage source type pseudo inertia control is called a voltage source type distributed power supply. A distributed power supply capable of executing the current source type pseudo inertia control is called a current source type distributed power supply. In a power system in which the voltage source type distributed power supply and the current source type distributed power supply coexist, a range of a voltage frequency from the power system is determined by a drooping characteristic and a rated capacity of the voltage source type distributed power supply. Depending on a drooping characteristic of the current source type distributed power supply, a capacity of output power unique to the current source type distributed power supply is not utilized, and adjustment capability is not sufficiently exhibited in some cases.

One object of the present disclosure is to provide a distributed power supply integrated management system, a distributed power supply integrated management device, and a distributed power supply integrated management method that solve the above-described problems.

### Solution to Problem

A first aspect is a distributed power supply integrated management system that manages a plurality of distributed power supplies, in which the plurality of distributed power supplies at least includes one voltage source type distributed power supply and one current source type distributed power supply, the voltage source type distributed power supply operates as a voltage source and has a first type drooping characteristic that is a drooping characteristic in which a voltage frequency changes according to output power, the current source type distributed power supply operates as a current source and has a second type drooping characteristic that is a drooping characteristic in which output power changes according to a voltage frequency, and the distributed power supply integrated management system includes: a drooping characteristic determinator that determines control information that provides the second type drooping characteristic on the basis of the first type drooping characteristic in a control range of a common voltage frequency; and a control information setter that sets the control information in the current source type distributed power supply.

A second aspect is a distributed power supply integrated management device that manages a plurality of distributed power supplies, in which the plurality of distributed power supplies at least includes one voltage source type distributed power supply and one current source type distributed power supply, the voltage source type distributed power supply operates as a voltage source and has a first type drooping characteristic that is a drooping characteristic in which a voltage frequency changes according to output power, the current source type distributed power supply operates as a current source and has a second type drooping characteristic that is a drooping characteristic in which output power changes according to a voltage frequency, and the distributed power supply integrated management device includes: a drooping characteristic determinator that determines control information that provides the second type drooping characteristic on the basis of the first type drooping characteristic in a control range of a common voltage frequency; and a control information setter that sets the control information in the current source type distributed power supply.

A third aspect is a program for causing a computer to manage a plurality of distributed power supplies at least including one voltage source type distributed power supply and one current source type distributed power supply, in which the voltage source type distributed power supply operates as a voltage source and has a first type drooping characteristic that is a drooping characteristic in which a voltage frequency changes according to output power, the current source type distributed power supply operates as a current source and has a second type drooping characteristic that is a drooping characteristic in which output power changes according to a voltage frequency, and the program is a program for causing the computer to determine control information that provides the second type drooping characteristic on the basis of the first type drooping characteristic in a control range of a common voltage frequency and set the control information in the current source type distributed power supply.

A fourth aspect is a distributed power supply integrated management method in a distributed power supply integrated management system that manages a plurality of distributed power supplies, in which the plurality of distributed power supplies at least includes one voltage source type distributed power supply and one current source type distributed power supply, the voltage source type distributed power supply operates as a voltage source and has a first type drooping characteristic that is a drooping characteristic in which a voltage frequency changes according to output power, the current source type distributed power supply operates as a current source and has a second type drooping characteristic that is a drooping characteristic in which output power changes according to a voltage frequency, a drooping characteristic determinator determines control information that provides the second type drooping characteristic on the basis of the first type drooping characteristic in a control range of a common voltage frequency, and a control information setter sets the control information in the current source type distributed power supply.

### Advantageous Effects of Invention

According to the present disclosure, adjustment capability of output power of a current source type distributed power supply can be exhibited.

### BRIEF DESCRIPTION OF DRAWINGS

FIG. 1 is a schematic block diagram illustrating a configuration example of a distributed power supply integrated management system according to the present disclosure.

FIG. 2 is a schematic block diagram illustrating a functional configuration example of a distributed power supply integrated management device according to the present disclosure.

FIG. 3 is a schematic block diagram illustrating a functional configuration example of a voltage source type distributed power supply according to the present disclosure.

FIG. 4 is a schematic block diagram illustrating a functional configuration example of a current source type distributed power supply according to the present disclosure.

FIG. 5 is a block diagram illustrating an example of a first type drooping characteristic control mechanism according to the present disclosure.

FIG. 6 is a block diagram illustrating an example of a second type drooping characteristic control mechanism according to the present disclosure.

FIG. 7 is an explanatory diagram illustrating a first control example of a drooping characteristic according to the present disclosure.

FIG. 8 is an explanatory diagram illustrating a second control example of the drooping characteristic according to the present disclosure.

FIG. 9 is a flowchart illustrating an example of a drooping characteristic control flow according to the present disclosure.

### DESCRIPTION OF EMBODIMENTS

Hereinafter, an embodiment will be described with reference to the drawings. Elements common to or corresponding to the drawings are denoted by the same reference numerals, and description thereof is incorporated unless otherwise specified.

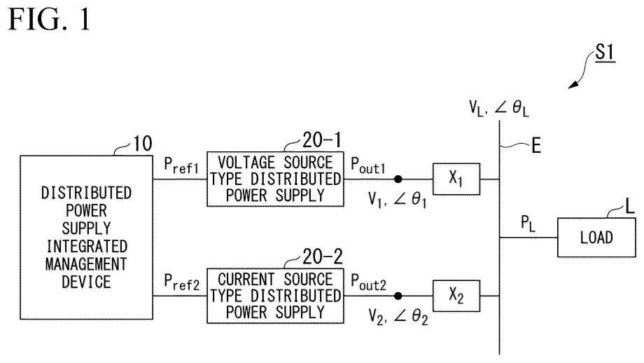

FIG. 1 is a schematic block diagram illustrating a configuration example of a distributed power supply integrated management system S1 according to the present disclosure. The distributed power supply integrated management system S1 includes a distributed power supply integrated management device 10 and a plurality of distributed power supplies 20. The distributed power supply integrated management system S1 may be included in a component of a self-sustaining power system for supplying power from the plurality of distributed power supplies 20 to a load L via a power transmission network E.

The distributed power supply integrated management device 10 manages the plurality of distributed power supplies 20. The plurality of distributed power supplies 20 constitute a self-sustaining power system. The power system can be configured as a so-called microgrid. The distributed power supply integrated management device 10 manages power supply configuration data in the power system. The power supply configuration data is data indicating information such as the type, power supply capability, and installation position of each of the distributed power supplies 20. The distributed power supply integrated management device 10 controls output power supplied from each of the distributed power supplies 20.

The distributed power supply integrated management device 10 may cause a distributed power supply 20 including a storage battery to perform charge or discharge. The distributed power supply integrated management device 10 determines control information for controlling a drooping characteristic of the distributed power supply 20, and sets the determined control information in a corresponding distributed power supply 20. The distributed power supply integrated management system S1 or the distributed power supply integrated management device 10 may be configured as, for example, any one of a community energy management system (CEMS), an aria energy management system (AEMS), and a building and energy management system (BEMS).

Each of the plurality of distributed power supplies 20 can supply power, and sends power to be supplied to the power transmission network E. Each of the plurality of distributed power supplies 20 is an inverter power supply that executes pseudo inertia control. In the example of FIG. 1, the number of the distributed power supplies 20 is two, but may be three or more. The distributed power supply 20 may be, for example, a storage battery or a generator. The storage battery may be, for example, any one of a lithium-ion battery and a sodium ion battery. The generator is, for example, a synchronous generator that generates three-phase AC power. The distributed power supply 20 may include both a storage battery and a synchronous generator. A distributed power supply 20 including a storage battery may store surplus power generated in the power transmission network E. In the present application, output power may mean a power flow. That is, in the present application, power received by the distributed power supply 20 from the power transmission network E may be treated as negative output power and may be handled in an integrated manner with output power supplied to the power transmission network E.

The plurality of distributed power supplies 20 includes at least one voltage source type distributed power supply and at least one current source type distributed power supply. The voltage source type distributed power supply is a power supply that executes pseudo inertia control and operates as a constant voltage source and a variable current source. The voltage source type distributed power supply has a drooping characteristic in which a voltage frequency changes according to a change in output power. In the present application, the drooping characteristic of the voltage source type distributed power supply may be referred to as a “first type drooping characteristic”. The first type drooping characteristic is also referred to as a P-f drooping characteristic. The current source type distributed power supply is a power supply that operates as a variable voltage source and a constant current source. The current source type distributed power supply has a drooping characteristic in which output power changes according to a change in voltage frequency. In the present application, the drooping characteristic of the current source type distributed power supply may be referred to as a “second type drooping characteristic”. The second type drooping characteristic is also referred to as an f-P drooping characteristic.

The drooping characteristic of each of the distributed power supplies 20 is determined by control information. The distributed power supply integrated management device 10 determines control information for the voltage source type distributed power supply on the basis of an output power command value for the voltage source type distributed power supply and a rated range of output power. The rated range of the output power means a range of output power that can be supplied, and is defined by a lower limit value and an upper limit value. The rated range of the output power may be defined as a rated capacity of the output power. The rated range of the output power can be set in advance in the power supply configuration data as an element of power supply capability indicated in the power supply configuration data. A control range of a voltage frequency corresponding to the rated capacity of the output power is determined under the first type drooping characteristic determined by the control information. The distributed power supply integrated management device 10 determines control information for controlling the second type drooping characteristic for the current source type distributed power supply on the basis of the first type drooping characteristic in the control range of the voltage frequency of the voltage source type distributed power supply. The voltage frequency is a frequency of an output voltage that is AC power.

In the following description, a case where the number of the distributed power supplies 20 in the power system is two will be mainly described. One of the two distributed power supplies 20 is a voltage source type distributed power supply 20-1, and the other is a current source type distributed power supply 20-2. The voltage source type distributed power supply 20-1 is, for example, a grid forming (GFM) controlled storage battery. The GFM control is pseudo inertia control in which operation is performed so as to maintain an output voltage and a voltage frequency from a power supply. The current source type distributed power supply 20-2 is, for example, a grid following (GFL) control storage battery. The GFL control is pseudo inertia control in which operation is performed so as to follow a voltage and a voltage frequency of a power system.

In the example of FIG. 1, an output power command value P_{ref1} and control information are set in the voltage source type distributed power supply 20-1. The voltage source type distributed power supply 20-1 sets the output power command value P_{ref1} as a target value, and controls output power Pₒᵤₜ₁ on the basis of the set control information. The voltage source type distributed power supply 20-1 maintains an output voltage V₁ and makes an output current variable in control of the output power Pₒᵤₜ₁. A variation of a voltage frequency f₁ of the output power appears as a variation of its phase <θ₁. The voltage source type distributed power supply 20-1 sends the output power Pₒᵤₜ₁ to the power transmission network E.

An output power command value P_{ref2} and control information are set in the current source type distributed power supply 20-2. The current source type distributed power supply 20-2 controls output power Pₒᵤₜ₂ on the basis of control information in which the output power command value P_{ref2} is set as a target value. The current source type distributed power supply 20-2 maintains an output current and makes an output voltage V₂ variable in control of the output power Pₒᵤₜ₂. A variation of a voltage frequency f₂ of the output power appears as a variation of its phase 202. The current source type distributed power supply 20-2 sends the output power Pₒᵤₜ₂ to the power transmission network E.

Power P_{L} is supplied to the load L via the power transmission network E. The load L is a facility that consumes power. For example, a dwelling, a public facility, a commercial facility, or a communication facility corresponds to the load L. The supply power P_{L} includes components of the output power Pₒᵤₜ₁ and Pₒᵤₜ₂. The power transmission network E includes facilities of a substation, a transmission line, and a transformer. The components of the output power Pₒᵤₜ₁ and Pₒᵤₜ₂ are attenuated in a transmission process, and phases thereof fluctuate due to electromagnetic induction. A voltage V_{L} and a phase <0y0y_{L} of the supply power are related to an amplitude of the voltage V₁ and the phase 201 of the output power Pₒᵤₜ₁ by a power transmission reactance X₁ from the voltage source type distributed power supply 20-1 to a load bus. The voltage V_{L} and the phase 20L of the supply power are related to an amplitude of the voltage V₂ and the phase 202 of the output power Pₒᵤₜ₂ by a power transmission reactance X₂ from the current source type distributed power supply 20-2 to the load bus.

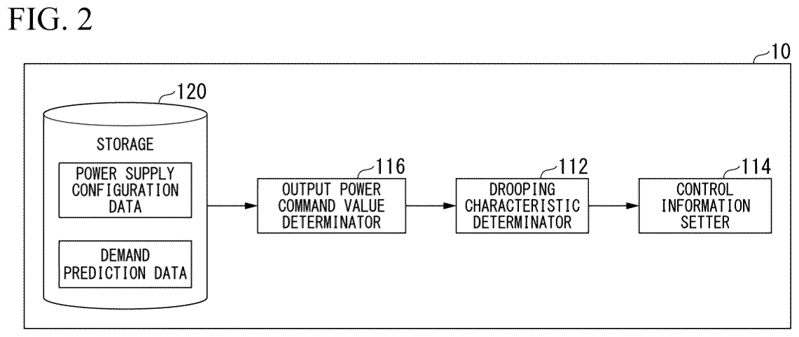

Next, a functional configuration example of the distributed power supply integrated management device 10 according to the present disclosure will be described. FIG. 2 is a schematic block diagram illustrating a functional configuration example of the distributed power supply integrated management device 10 according to the present disclosure. The distributed power supply integrated management device 10 includes a drooping characteristic determinator 112, a control information setter 114, an output power command value determinator 116, and a storage 120.

The drooping characteristic determinator 112 determines control information for performing control such that output power Pₒᵤₜ from each of the distributed power supplies 20 approximates an output power command value P_{ref}.

For example, the drooping characteristic determinator 112 determines a control configuration and a control parameter so as to provide the first type drooping characteristic which is included in a control range of output power based on a control point and in which a voltage frequency monotonously increases according to a decrease in output power for the voltage source type distributed power supply 20-1.

The drooping characteristic determinator 112 determines the output power Pₒᵤₜ₁ at a control point of the voltage source type distributed power supply 20-1 as the output power command value P_{ref1}, and determines a voltage frequency f₁ as a rated frequency fₙ. The control configuration means a model indicating an input/output relationship. As the control configuration, a control element representing a model or a combination thereof may be indicated. As the control element, for example, a delay element, an integral element, or a proportional element can be indicated. In the present application, one or both of the control configuration and the control parameter, or other various types of information used for control may be collectively referred to as “control information”. Specific examples of the control configuration and the control parameter will be described later.

The control range of the output power is defined by a lower limit and an upper limit of the output power. For example, the drooping characteristic determinator 112 sets a value smaller than output power at a control point by a constant rated capacity Pₙ as a lower limit Pₘᵢₙ of the output power. For example, the drooping characteristic determinator 112 sets a value larger than the output power at the control point by the constant rated capacity Pₙ as an upper limit Pₘₐₓ of the output power. As the rated capacity Pₙ, output power that can be stably supplied by the voltage source type distributed power supply 20-1 or input power that can be stably received by the voltage source type distributed power supply 20-1 may be set in advance. The control range of the output power based on the rated capacity Pₙ can also be regarded as a rated range.

Next, the drooping characteristic determinator 112 determines a voltage frequency corresponding to the upper limit Pₘₐₓ of the output power as a lower limit fₘᵢₙ of the voltage frequency and determines a voltage frequency corresponding to the lower limit Pₘᵢₙ of the output power as an upper limit fₘₐₓ of the voltage frequency on the basis of the first type drooping characteristic determined by the control information for the voltage source type distributed power supply 20-1. A value range between the lower limit fₘᵢₙ and the upper limit fₘₐₓ of the voltage frequency corresponds to a rated range of the voltage frequency. The rated range of the voltage frequency has a value range including the rated frequency fₙ as a reference value. A difference between the lower limit fₘᵢₙ and the upper limit fₘₐₓ of the voltage frequency corresponds to a fluctuation range of the voltage frequency. In a commercial power supply, the rated frequency fₙ is, for example, 50 Hz or 60 Hz. A fluctuation range of the voltage frequency is, for example, 0.2 to 0.6 Hz.

Then, the drooping characteristic determinator 112 determines the control information of the current source type distributed power supply 20-2 such that the control range of the output power varying depending on a change in voltage frequency in the control range of the voltage frequency provides the second type drooping characteristic including the control range of the output power by the first type drooping characteristic. As the control information, one or both of a control configuration and a control parameter that provide the second type drooping characteristic are determined.

For example, in a value range of output power that is equal to or more than the output power command value, the drooping characteristic determinator 112 in the rated range may determine the second type drooping characteristic such that a lower limit of the voltage frequency corresponding to an upper limit of the rated range of the output power is equal to or higher than a lower limit of the rated range of the voltage frequency by the first type drooping characteristic.

In a value range of output power that is equal to or less than the output power command value, the drooping characteristic determinator 112 may determine the second type drooping characteristic such that an upper limit of the voltage frequency corresponding to a lower limit of the rated range of the output power is equal to or lower than an upper limit of the voltage frequency by the first type drooping characteristic. A method for determining the second type drooping characteristic of the current source type distributed power supply 20-2 will be described later.

The drooping characteristic determinator 112 outputs control information determined for each of the distributed power supplies 20 to the control information setter 114.

The control information setter 114 sets the control information input from the drooping characteristic determinator 112 in a distributed power supply 20 to be applied. The control information setter 114 includes, for example, an input/output interface. The input/output interface is connected to another device using a predetermined input/output system such that various types of data can be input/output in a wired or wireless manner. An input/output counterpart is the distributed power supply 20. The input/output interface may be connected to another device via a communication network using a predetermined communication system.

The output power command value determinator 116 can determine an output power command value for each of the distributed power supplies 20 by performing optimum calculation so as to satisfy all of the following constraint conditions I to III.
I. A sum of output power command values from the distributed power supplies 20 is equal to total demand power.
II. The output power command value from each of the distributed power supplies 20 is within a range of outputtable power of the distributed power supply 20.
III. A power flow is equal to or less than a transmission capacity limit of each transmission line constituting the power transmission network E.

The output power command value determinator 116 notifies the drooping characteristic determinator 112 of an output power command value determined for each of the distributed power supplies 20. A timing of setting the output power command value of each of the distributed power supplies 20 may be every fixed time (for example, 15 minutes to one hour), or may be a time point instructed by a user operation or execution of a program.

By referring to power supply configuration data stored in the storage 120, the output power command value determinator 116 can find an output capacity, a transmission capacity of a transmission line connected to each of the distributed power supplies 20, and a transmission line reactance as element items of power supply capability of each of the distributed power supplies 20.

An objective function used for the optimum calculation may be determined in advance, or may be used depending on a demand trend of power, a supply policy, and other factors. For example, as an objective function for emphasizing an economic viewpoint, a function that provides a monotonically changing function value with respect to running cost for output power from each of the distributed power supplies 20 is used. As an objective function for emphasizing a viewpoint of state of charge (SOC) management of a storage battery, a function that provides a monotonically changing function value with respect to SOC of a storage battery included in the distributed power supply 20 is used. As an objective function for emphasizing a viewpoint of a loss in power transmission, a function that provides a monotonically changing function value with respect to a power loss of the entire power transmission network E is used. The objective function may be a weighted sum of functions related to the viewpoints. A weighting factor for each function only needs to be set according to a degree of emphasis on a corresponding viewpoint. In the present application, the optimum calculation includes searching for a more appropriate solution. In the optimum calculation, an absolutely appropriate solution cannot be obtained in some cases.

For example, the output power command value determinator 116 can determine total demand power on the basis of power consumption in the load L and a loss from each of the distributed power supplies 20 to the load L. The loss is determined on the basis of a power transmission reactance. The output power command value determinator 116 is notified of power consumption measured from each load L. The output power command value determinator 116 can calculate, as the total demand power, a sum of demand power for each load L obtained by correcting attenuation and a phase change due to a transmission reactance from each of the distributed power supplies 20 to the load L for the notified power consumption. The output power command value determinator 116 may calculate the total demand power by multiplying the sum of the demand power by a predetermined safety coefficient larger than 1.

The output power command value determinator 116 may determine the output power command value of each of the distributed power supplies 20 on the basis of total demand power at a target time point after the current time point by referring to demand prediction data. Demand prediction data indicating a time series including a prediction value of total demand power at each time point is stored in the storage 120 in advance. The output power command value determinator 116 can calculate a prediction value of the total demand power using a mathematical model on the basis of weather prediction at a future target time point with respect to an actual value of power consumption at each load L at each time point in the past, climate (temperature, humidity, or weather) at the time point, and the like. As the mathematical model, for example, a linear regression model such as an autoregressive model may be used, or a nonlinear model such as a neural network may be used.

The storage 120 stores various types of data. The storage 120 stores, for example, one or both of the power supply configuration data and the demand prediction data. The storage 120 includes a storage medium such as a random-access memory (RAM), a read only memory (ROM), a solid-state drive (SSD), or a hard disk drive (HDD).

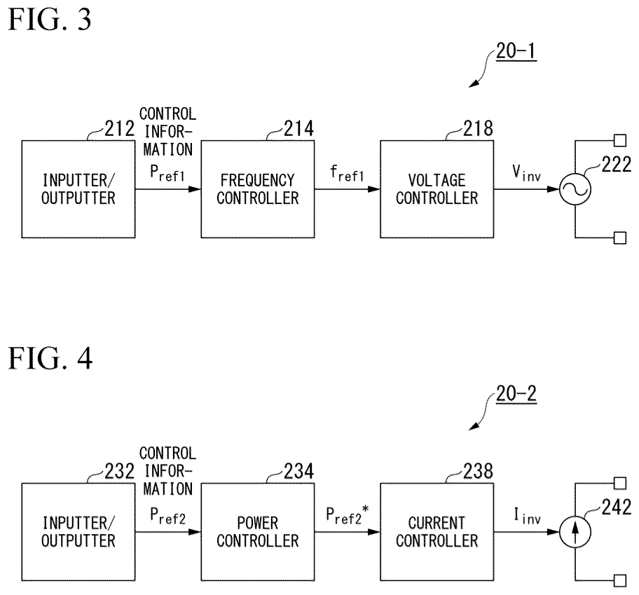

Next, a functional configuration example of the voltage source type distributed power supply 20-1 according to the present disclosure will be described. FIG. 3 is a schematic block diagram illustrating a functional configuration example of the voltage source type distributed power supply 20-1 according to the present disclosure.

The voltage source type distributed power supply 20-1 includes an inputter/outputter 212, a frequency controller 214, a voltage controller 218, and a voltage source inverter 222.

The inputter/outputter 212 outputs control information and an output power command value input from the distributed power supply integrated management device 10 to the frequency controller 214. The inputter/outputter 212 includes, for example, an input/output interface. The input/output interface is connected to another device using a predetermined input/output system such that various types of data can be input/output in a wired or wireless manner.

The frequency controller 214 receives the control information and the output power command value P_{ref1} from the distributed power supply integrated management device 10 via the inputter/outputter 212. The frequency controller 214 controls the voltage frequency f₁ according to the control information such that a deviation between the output power command value P_{ref1} and the output power Pₒᵤₜ₁ output from the voltage source inverter 222 approximates zero. The frequency controller 214 specifies a control parameter instructed by the received control information and sets the specified control parameter in the frequency controller 214. The frequency controller 214 uses a control parameter set in control of the voltage frequency. When the control configuration is instructed by the control information, the frequency controller 214 sets the control configuration in the frequency controller 214. The frequency controller 214 controls the voltage frequency under the set control configuration. A control characteristic of the voltage frequency obtained for the output power Pₒᵤₜ₁ corresponds to the first type drooping characteristic. The frequency controller 214 notifies the voltage controller 218 of the obtained voltage frequency as a target voltage frequency f_{ref1}.

The voltage controller 218 is notified of the target voltage frequency f_{ref1} by the frequency controller 214. The voltage controller 218 generates a voltage control signal Vᵢₙᵥ indicating generation of an AC voltage having a predetermined rated voltage Vₘ as an amplitude and the target voltage frequency f_{ref1} as a frequency. The voltage controller 218 outputs the generated voltage control signal Vᵢₙᵥ to the voltage source inverter 222. An example of a first type drooping characteristic control mechanism will be described later.

The voltage source inverter 222 includes a power supply and an inverter. The power supply is a member or a device that supplies power. The power supply may include any element member such as a storage battery, a solar panel, a wind power generator, or a synchronous generator. The power supply may be configured by stacking a plurality of element members in series or may be arranged in parallel.

According to the voltage control signal Vᵢₙᵥ input from the voltage controller 218, the inverter converts power supplied from the power supply into an AC voltage having the rated voltage Vₘ as an amplitude and the target voltage frequency f_{ref1} as a frequency. The inverter sends the obtained AC voltage to the power transmission network E.

Next, a functional configuration example of the current source type distributed power supply 20-2 according to the present disclosure will be described. FIG. 4 is a schematic block diagram illustrating a functional configuration example of the current source type distributed power supply 20-2 according to the present disclosure.

The current source type distributed power supply 20-2 includes an inputter/outputter 232, a power controller 234, a current controller 238, and a current source inverter 242.

The inputter/outputter 232 outputs control information and an output power command value input from the distributed power supply integrated management device 10 to the power controller 234. The inputter/outputter 232 includes, for example, an input/output interface. The input/output interface is connected to another device using a predetermined input/output system such that various types of data can be input/output in a wired or wireless manner.

The power controller 234 receives the control information from the distributed power supply integrated management device 10 via the inputter/outputter 232. The power controller 234 controls the output power Pₒᵤₜ₂ according to the control information such that a deviation between a predetermined rated frequency fₙ and a voltage frequency fₘₑₐₛᵤᵣₑ₂ of output power output from the current source inverter 242 approximates zero.

The power controller 234 specifies a control parameter instructed by the received control information and sets the specified control parameter in the power controller 234.

The power controller 234 uses a control parameter set in control of the output power. When the control configuration is instructed by the control information, the power controller 234 sets the control configuration in the power controller 234. The power controller 234 controls the output power under the set control configuration. A control characteristic of the output power obtained for the voltage frequency fₘₑₐₛᵤᵣₑ₂ corresponds to the second type drooping characteristic. The power controller 234 notifies the current controller 238 of the obtained output power as target output power P*_{ref2}. A configuration example of second type drooping characteristic control will be described later.

The current controller 238 is notified of the target output power P*_{ref2} by the power controller 234. The current controller 238 divides the target output power P*_{ref2} by the rated voltage Vₘ to convert the target output power P*_{ref2} into a target current I_{ref2}. The current controller 238 calculates a deviation ΔI between the target current I_{ref2} and a current measured value Iₘₑₐₛᵤᵣₑ₂ of the output power output from the current source inverter 242. The current controller 238 calculates a voltage amplitude deviation by performing feedback control such that the deviation ΔI approximates zero. As the feedback control, for example, PI control or PID control can be applied.

The current controller 238 adds a measured value |Vₘₑₐₛᵤᵣₑ₂| of a voltage amplitude of the output power output from the current source inverter 242 to the calculated voltage amplitude deviation to calculate a voltage amplitude target value |V_{ref2}|. The current controller 238 generates a current control signal Iᵢₙᵥ indicating generation of an AC voltage having the voltage amplitude target value |V_{ref2}| as an amplitude. The current controller 238 outputs the generated current control signal Iᵢₙᵥ to the current source inverter 242.

The current source inverter 242 includes a power supply and an inverter. The inverter converts power supplied from the power supply into an AC voltage having the voltage amplitude target value |V*_{ref2}| as an amplitude according to the current control signal Iᵢₙᵥ input from the current controller 238. The inverter sends the obtained AC voltage to the power transmission network E.

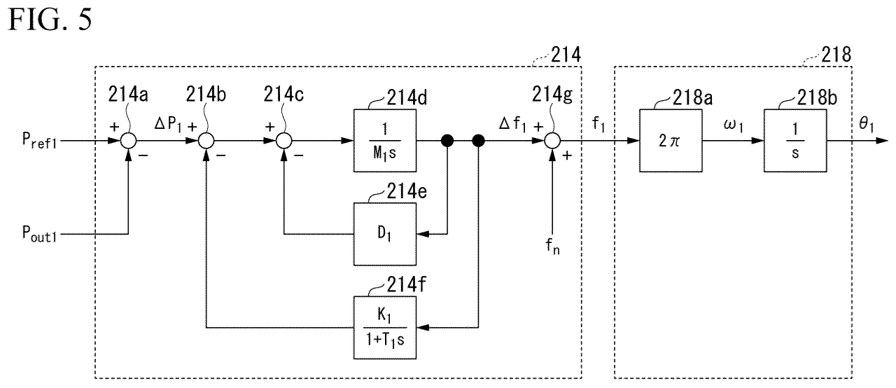

Next, an example of a first type drooping characteristic control mechanism according to the present disclosure will be described. FIG. 5 is a block diagram illustrating an example of the first type drooping characteristic control mechanism according to the present disclosure. The frequency controller 214 includes subtractors 214a, 214b, and 214c, an integrator 214d, a multiplier 214e, a speed governor 214f, and an adder 214g.

To the subtractor 214a, the output power command value P_{ref1} is input via the inputter/outputter 212, and a measured value of the output power Pₒᵤₜ₁ from the voltage source inverter 222 (FIG. 3) is input. The subtractor 214a outputs a difference value obtained by subtracting the output power Pₒᵤₜ₁ from the output power command value P_{ref1} to the subtractor 214b as an output power deviation ΔP₁.

To the subtractor 214b, the output power deviation ΔP₁ is input from the subtractor 214a, and an output value (hereinafter, also referred to as a “speed governor output value”) from the speed governor 214f is input. The subtractor 214b outputs a difference value (hereinafter, also referred to as a “speed governor output difference value”) obtained by subtracting the speed governor output value from the output power deviation ΔP₁ to the subtractor 214c.

To the subtractor 214c, the speed governor output difference value is input from the subtractor 214b, and the subtractor 214c outputs, to the integrator 214d, a difference value (hereinafter, also referred to as a “multiplier output difference value”) obtained by subtracting an output value (hereinafter, also referred to as a “subtractor output value”) from the multiplier 214e.

The integrator 214d divides the subtractor output difference value input from the subtractor 214c by an inertia parameter M₁. The inertia parameter M₁ indicates the magnitude of an inertia force of the voltage source type distributed power supply 20-1. The integrator 214d integrates a quotient obtained by the division by the inertia parameter M₁ to calculate a voltage frequency deviation Δf₁. The integrator 214d outputs the calculated voltage frequency deviation Δf₁ to each of the multiplier 214e, the speed governor 214f, and the adder 214g.

The multiplier 214e multiplies the voltage frequency deviation Δf₁ input from the integrator 214d by a braking parameter D₁. The braking parameter D₁ indicates a degree of attenuating the voltage frequency deviation Δf₁. The multiplier 214e feeds back a product obtained by the multiplication to the subtractor 214c as a multiplier output value. The speed governor 214f constitutes a first-order delay element. The speed governor 214f calculates a speed governor output value by applying a transfer function K₁/(1+T₁s) to the voltage frequency deviation Δf₁ input from the integrator 214d. T₁ represents a speed governor time constant. The speed governor time constant T₁ is a time constant corresponding to an integration time. The speed governor time constant T₁ indicates a degree of a pseudo inertial force with respect to the voltage frequency deviation Δf₁. K₁ represents a speed governor gain. The speed governor 214f feeds back the calculated speed governor output value to the subtractor 214b.

The adder 214g outputs a sum of the voltage frequency deviation Δf₁ input from the integrator 214d and the predetermined rated frequency fₙ to the voltage controller 218 as the voltage frequency f₁.

The voltage controller 218 includes a multiplier 218a and an integrator 218b. The multiplier 218a multiplies the voltage frequency f₁ input from the frequency controller 214 by a constant 2π to convert the voltage frequency f₁ into an angular frequency ω₁. The multiplier 218a outputs the converted angular frequency ω₁ to the integrator 218b.

The integrator 218b integrates the angular frequency ω₁ input from the multiplier 218a to convert the angular frequency ω1 into a phase θ₁. The voltage controller 218 generates the voltage control signal Vᵢₙᵥ indicating a voltage having the rated voltage Vₘ as an amplitude and the phase θ₁. The voltage controller 218 outputs the generated voltage control signal Vᵢₙᵥ to the voltage source inverter 222.

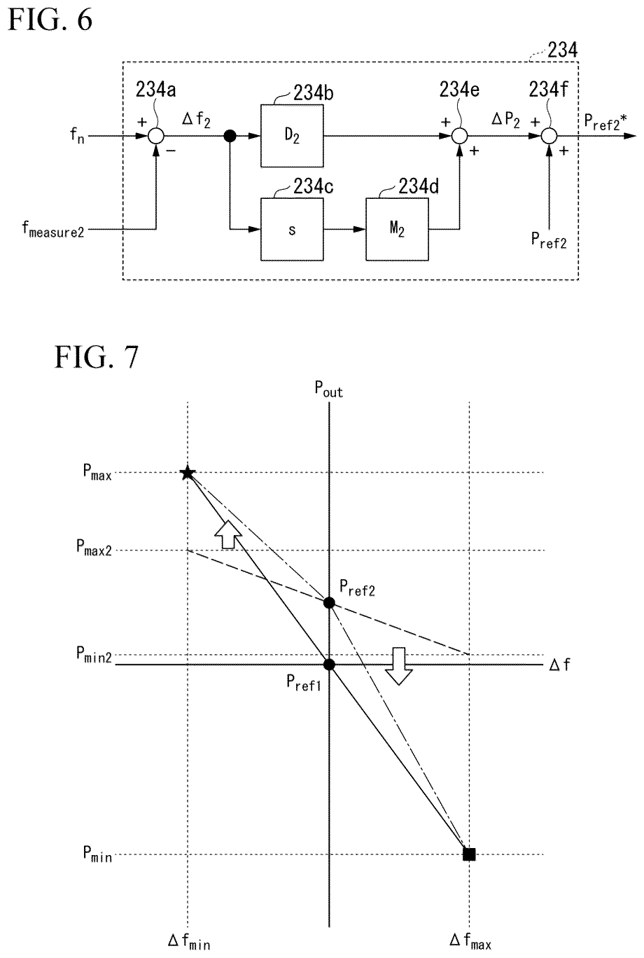

Next, an example of a second type drooping characteristic control mechanism according to the present embodiment will be described. FIG. 6 is a block diagram illustrating a configuration example of the second type drooping characteristic control according to the present embodiment. The frequency controller 234 includes a subtractor 234a, a multiplier 234b, a differentiator 234c, a multiplier 234d, and adders 234e and 234f.

To the subtractor 234a, the measured value fₘₑₐₛᵤᵣₑ₂ of the voltage frequency for the output power Pₒᵤₜ₂ from the current source inverter 242 (FIG. 4) is input. The subtractor 234a outputs a difference value obtained by subtracting the measured value fₘₑₐₛᵤᵣₑ₂ of the voltage frequency from the predetermined rated frequency fₙ to the multiplier 234b and the differentiator 234c as a voltage frequency deviation Δf₂.

The multiplier 234b multiplies the voltage frequency deviation Δf₂ input from the subtractor 234a by a braking parameter D₂. The multiplier 234b outputs a product obtained by the multiplication to the adder 234e as a proportional product.

The differentiator 234c differentiates the voltage frequency deviation Δf₂ input from the subtractor 234a. The differentiator 234c outputs a differential value obtained by the differentiation to the multiplier 234d.

The multiplier 234d outputs a product obtained by multiplying the differential value input from the differentiator 234c by an inertia parameter M₂ to the adder 234e as a differential product.

To the adder 234e, the proportional product is input from the multiplier 234b, and the differential product is input from the multiplier 234d. The adder 234e outputs a sum of the proportional product and the differential product to the adder 234f as an output power deviation ΔP₂.

To the adder 234f, the output power deviation ΔP₂ is input from the adder 234e, and the output power command value P_{ref2} is input via the inputter/outputter 232. The adder 234f outputs a sum of the output power deviation ΔP₂ and the output power command value P_{ref2} to the current controller 238 as a new output power command value P*_{ref2}.

Note that, in the above description, the case where the output power is active power has been exemplified, but the output power command value determinator 116 of the distributed power supply integrated management device 10 may calculate a reactive power command value for each of the distributed power supplies 20 using a known method. The output power command value determinator 116 notifies each of the distributed power supplies 20 of the calculated reactive power command value via the control information setter 114.

In the example of FIG. 3, the case where the target amplitude voltage |V_{ref1}| is the rated voltage Vₘ in the voltage controller 218 of the voltage source type distributed power supply 20-1 has been exemplified, but the target amplitude voltage |V_{ref1}| may be variable on the basis of a reactive power command value Q_{ref1}.

More specifically, the voltage source type distributed power supply 20-1 may include an amplitude controller (not illustrated) that determines the target amplitude voltage |V_{ref1}| on the basis of the reactive power command value Q_{ref1}. The amplitude controller controls an amplitude voltage deviation such that a deviation ΔQ between the reactive power command value Q_{ref1} received from the distributed power supply integrated management device 10 and a reactive power actual measurement value Qₒᵤₜ₁ approximates zero. The amplitude controller can determine the target amplitude voltage |V_{ref1}| by adding the rated voltage Vₘ to the amplitude voltage deviation.

In the example of FIG. 4, the case where the current controller 238 divides the target output power P_{ref2} by the rated voltage Vₘ to convert the target output power P*_{ref2} into the target current I_{ref2} has been exemplified, but the current controller 238 may perform conversion from the reactive power command value Q_{ref2} and the target output power P*_{ref2} into the target current I_{ref2}. When performing conversion into the target current I_{ref2}, the current controller 238 calculates a deviation ΔI between the target current I_{ref2} and an output current measured value Iₘₑₐₛᵤᵣₑ₂ from the current source inverter 242. The current controller 238 performs feedback control such that the deviation ΔI approximates zero and a voltage deviation is calculated. The current controller 238 outputs a control signal indicating a voltage target value obtained by adding the calculated voltage deviation and an actual measurement value of a voltage amplitude from the current source inverter 242 to the current source inverter 242.

The current source inverter 242 sends output power having a voltage corresponding to a voltage target value instructed by the control signal input from the current controller 238 to the power transmission network E.

Next, a first control example of a drooping characteristic according to the present disclosure will be described. FIG. 7 is an explanatory diagram illustrating the first control example of the drooping characteristic according to the present disclosure. The illustrated drooping characteristic illustrates a correlation of output power Pₒᵤₜ with a voltage frequency. In FIG. 7, the horizontal axis represents a voltage frequency deviation Δf, and the vertical axis represents output power Pₒᵤₜ. Pₘₐₓ and Pₘᵢₙ represent an upper limit and a lower limit of output power, respectively. A black circle at an origin exemplifies a control point of the voltage source type distributed power supply 20-1. Output power Pₒᵤₜ₁ at the control point of the voltage source type distributed power supply 20-1 is set as an output power command value P_{ref1}. A black circle illustrated above the origin on the vertical axis exemplifies a control point of the current source type distributed power supply 20-2. Output power Pₒᵤₜ₂ at the control point of the current source type distributed power supply 20-2 is set as an output power command value P_{ref2}. The output power command value P_{ref2} of the current source type distributed power supply 20-2 is significantly larger than the output power command value P_{ref1} of the voltage source type distributed power supply 20-1.

The voltage frequency deviation Δf is common to the voltage source type distributed power supply 20-1 and the current source type distributed power supply 20-2. The voltage frequency deviation Δf is set to be zero for each of the control points of the voltage source type distributed power supply 20-1 and the current source type distributed power supply 20-2. That is, each of a voltage frequency f₁ at the control point of the voltage source type distributed power supply 20-1 and a voltage frequency f₂ at the control point of the current source type distributed power supply 20-2 is the rated frequency fₙ.

A solid line passing through the origin exemplifies the first type drooping characteristic of the voltage source type distributed power supply 20-1. A broken line passing through the control point P_{ref2} indicates the second type drooping characteristic of the current source type distributed power supply 20-2. Note that the second type drooping characteristic indicated by the broken line exemplifies an initial value determined without particularly considering a relationship with the first type drooping characteristic. The exemplified first type drooping characteristic and second type drooping characteristic both indicate that output power decreases with an increase in voltage frequency. Under these drooping characteristics, when a voltage frequency decreases due to an increase in power consumption, both the output power Pₒᵤₜ₁ from the voltage source type distributed power supply 20-1 and the output power Pₒᵤₜ₂ from the current source type distributed power supply 20-2 are controlled to increase.

The drooping characteristic determinator 112 of the distributed power supply integrated management device 10 can determine, as a control point, output power and a voltage frequency satisfying both of the following conditions A and B for each of the plurality of distributed power supplies constituting the self-sustaining power system.
A. A voltage frequency is common among the distributed power supplies 20.
B. A sum of output power command values from the distributed power supplies 20 is equal to total demand power.

In the example of FIG. 7, the condition A corresponds to that the voltage frequency f₁ of the voltage source type distributed power supply 20-1 is equal to the voltage frequency f₂ of the current source type distributed power supply 20-2. That is, the voltage frequency deviation Δf₁ of the voltage source type distributed power supply 20-1 and the voltage frequency deviation Δf₂ of the current source type distributed power supply 20-2 have a common value Δf. The condition B corresponds to that a sum of the output power Pₒᵤₜ₁ of the voltage source type distributed power supply 20-1 and the output power Pₒᵤₜ₂ of the current source type distributed power supply 20-2 is equal to total demand power P_{load}.

The drooping characteristic determinator 112 determines the output power at the control point of the voltage source type distributed power supply 20-1 as the output power command value P_{ref1}, and determines a control range of the output power as the rated range so as to include the output power command value P_{ref1}. In the example of FIG. 1, the upper limit Pₘₐₓ of the output power is set to a value larger than the output power Pₒᵤₜ₁ at the control point by the predetermined rated capacity Pₙ. The lower limit Pₘᵢₙ of the output power is set to a value smaller than the output power at the control point by the rated capacity Pₙ.

Note that when the distributed power supply 20 includes a storage battery, the drooping characteristic determinator 112 may set a rated output value in a discharge direction as the upper limit Pₘₐₓ of the output power, and may set a rated output value in a charge direction as the lower limit Pₘᵢₙ of the output power. The rated output value in the discharge direction can be a positive value, whereas the rated output value in the charge direction can be a negative value. Each of the rated output value in the discharge direction and the rated output value in the charge direction may be determined such that a heat generation amount due to charge/discharge is equal to or less than a heat dissipation amount that enables heat dissipation.

Then, the drooping characteristic determinator 112 determines the control range of the voltage frequency corresponding to the control range of the output power by referring to the first type drooping characteristic of the voltage source type distributed power supply 20-1. The drooping characteristic determinator 112 determines a voltage frequency deviation corresponding to the upper limit Pₘₐₓ of the output power as a lower limit Δfₘᵢₙ of the voltage frequency deviation. The drooping characteristic determinator 112 determines a voltage frequency deviation corresponding to the lower limit Pₘᵢₙ of the output power as an upper limit Δfₘₐₓ of the voltage frequency deviation.

According to the first type drooping characteristic of the exemplified voltage source type distributed power supply 20-1, the output power Pₒᵤₜ₁ monotonously decreases as the voltage frequency deviation Δf increases. The voltage frequency deviation Δf corresponds to a difference between the rated frequency fₙ and the voltage frequency f₁ of AC power supplied to the power system. This drooping characteristic indicates that the smaller the voltage frequency deviation Δf is, the more power is induced to be output. That is, when a voltage frequency of actually supplied output power decreases due to an increase in load in the power system, more power is required for the voltage source type distributed power supply 20-1.

On the other hand, it is indicated that as the load in the power system decreases and the voltage frequency deviation Δf increases, surplus power increases. Therefore, as the voltage frequency deviation Δf increases, power required for the power supply decreases. In this case, more power is charged in a distributed power supply including a storage battery. Note that control information for the voltage source type distributed power supply 20-1 may be determined in advance. Since the first type drooping characteristic is determined by the control information, the first type drooping characteristic may also be determined in advance. The first type drooping characteristic depends on the braking parameter D₁ and the speed governor gain K₁ among the control parameters illustrated in FIG. 5 and does not depend on the inertia parameter M₁ and the speed governor time constant T₁. This is because the inertia parameter M₁ and the speed governor time constant T₁ affect a transient characteristic of the voltage frequency deviation Δf with respect to a fluctuation of the output power Pₒᵤₜ₁.

The upper limit Pₘₐₓ and the lower limit Pₘᵢₙ of the output power can vary depending on factors such as the type of a distributed power supply and an output capacity. Also in the second type drooping characteristic of the exemplified current source type distributed power supply 20-2, the output power Pₒᵤₜ₂ monotonously decreases as the voltage frequency deviation Δf increases. An upper limit Pₘₐₓ₂ of the output power corresponding to the lower limit Δfₘᵢₙ of the voltage frequency deviation in the second type drooping characteristic is smaller than the upper limit Pₘₐₓ of the output power corresponding to the lower limit Δfₘᵢₙ of the voltage frequency deviation in the first type drooping characteristic. A lower limit Pₘᵢₙ₂ of the output power corresponding to the upper limit Δfₘₐₓ of the voltage frequency deviation in the second type drooping characteristic is larger than the lower limit Pₘᵢₙ of the output power corresponding to the upper limit Δfₘₐₓ of the voltage frequency deviation in the first type drooping characteristic.

In this state, assuming that a load increases, operating points move along the respective drooping characteristics. In the example of FIG. 7, the operating points move from right to left, and a set of output power and a voltage frequency satisfying the conditions A and B converges as new operating points. An output power difference Pₒᵤₜ₂ −Pₒᵤₜ₁ with respect to the voltage frequency deviation Δf decreases as the operating points move to left. Therefore, the current source type distributed power supply 20-2 cannot gradually respond to an increase in output power with respect to an increase in load. Then, when the output power Pₒᵤₜ₁ from the voltage source type distributed power supply 20-1 becomes larger than the output power Pₒᵤₜ₂ from the current source type distributed power supply 20-2, the voltage source type distributed power supply 20-1 mainly responds to an increase in load. That is, the current source type distributed power supply 20-2 cannot exhibit adjustment capability of the output power with respect to an increase in load as the entire power system.

On the other hand, in the present embodiment, the drooping characteristic determinator 112 determines control information that provides the second type drooping characteristic of the current source type distributed power supply 20-2 on the basis of the first type drooping characteristic in a rated range of an output frequency of the voltage source type distributed power supply 20-1. In the example of FIG. 7, the drooping characteristic determinator 112 determines the control information of the current source type distributed power supply 20-2 such that a value range from the lower limit Pₘᵢₙ₂ to the upper limit Pₘₐₓ₂, which is a control range of the output power by the second type drooping characteristic for a value range from the lower limit fₘᵢₙ to the upper limit fₘₐₓ, which is a control range of the voltage frequency, includes a value range from the lower limit Pₘᵢₙ to the upper limit Pₘₐₓ, which is a control range of the output power determined on the basis of the first type drooping characteristic.

More specifically, the drooping characteristic determinator 112 can determine, as the control information of the current source type distributed power supply 20-2, control information that provides the second type drooping characteristic in which a lower limit fₘᵢₙ₂ of the voltage frequency corresponding to the upper limit Pₘₐₓ of the control range of the output power is equal to the lower limit fₘᵢₙ of the control range of the voltage frequency. Therefore, a change amount of the output power with respect to a change in voltage frequency in the second type drooping characteristic becomes larger. When the voltage frequency is within the control range, the output power difference Pₒᵤₜ₂−Pₒᵤₜ₁ is zero or more. Therefore, adjustment capability of the output power with respect to a fluctuation of a load by the current source type distributed power supply 20-2 is utilized, and as a result, a fluctuation of the voltage frequency is suppressed.

In addition, the drooping characteristic determinator 112 may determine, as the control information of the current source type distributed power supply 20-2, control information that provides the second type drooping characteristic such that the upper limit fₘₐₓ₂ of the voltage frequency corresponding to the lower limit Pₘᵢₙ of the control range of the output power is equal to the upper limit fₘₐₓ of the control range of the voltage frequency. Also in this case, the change amount of the output power with respect to a change in voltage frequency in the second type drooping characteristic becomes larger. When the voltage frequency is within the control range, the output power difference Pₒᵤₜ₂−Pₒᵤₜ₁ is zero or more. Therefore, adjustment capability of the output power with respect to a fluctuation of a load by the current source type distributed power supply 20-2 is utilized, and as a result, a fluctuation of the voltage frequency is suppressed.

In FIG. 7, as a relationship between output power and a voltage frequency, the second type drooping characteristic passing through all of (Pₘᵢₙ, Δfₘₐₓ), (P_{ref2}, 0), and (Pₘₐₓ, Δfₘᵢₙ) is indicated by a dotted broken line. In the control configuration illustrated in FIG. 6, in order to exhibit the second type drooping characteristic, the drooping characteristic determinator 112 only needs to set different values to the braking parameter D₂ of the current source type distributed power supply 20-2 depending on whether the output power Pₒᵤₜ₂ from the current source type distributed power supply 20-2 is equal to or more than the output power command value P_{ref2} as output power at the control point. When the output power Pₒᵤₜ₂ from the current source type distributed power supply 20-2 is equal to or more than the output power command value P_{ref2}, the drooping characteristic determinator 112 determines a value of the braking parameter D₂ of the current source type distributed power supply 20-2 as D₂ₐ. When the output power Pₒᵤₜ₂ from the current source type distributed power supply 20-2 is less than the output power command value P_{ref2}, the drooping characteristic determinator 112 determines a value of the braking parameter D₂ of the current source type distributed power supply 20-2 as D_{2b}. D_{2b} represents a positive real number larger than D₂ₐ. As the braking parameter D₂ increases, a change in output voltage with respect to a change in voltage frequency increases.

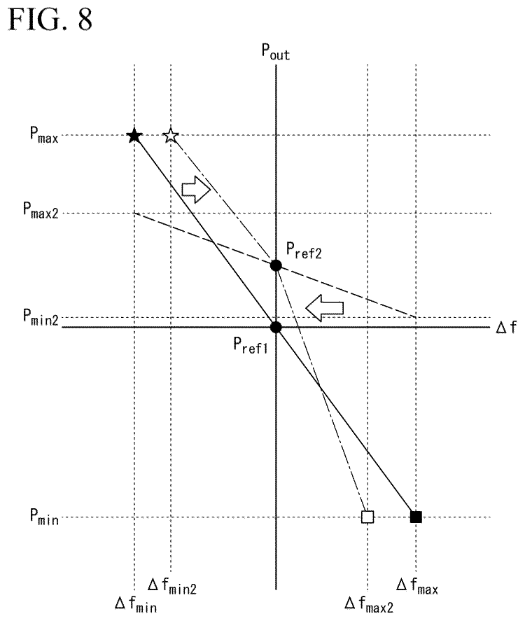

In addition, as illustrated in FIG. 8, the drooping characteristic determinator 112 may determine, as the control information of the current source type distributed power supply 20-2, control information that provides the second type drooping characteristic in which the minimum voltage frequency fₘᵢₙ₂ corresponding to the upper limit Pₘₐₓ of the control range of the output power is higher than the lower limit fₘᵢₙ of the control range of the voltage frequency. Therefore, the change amount of the output power with respect to a change in voltage frequency in the second type drooping characteristic becomes larger, and the output power Pₒᵤₜ₂ from the current source type distributed power supply 20-2 reaches the upper limit Pₘₐₓ of the control range of the output power even when the voltage frequency is higher than the lower limit fₘᵢₙ of the control range. Therefore, adjustment capability of the output power with respect to a fluctuation of a load by the current source type distributed power supply 20-2 is further exhibited, and a fluctuation of the voltage frequency is further suppressed.

The drooping characteristic determinator 112 may determine, as the control information of the current source type distributed power supply 20-2, control information that provides the second type drooping characteristic in which the maximum voltage frequency fₘₐₓ₂ corresponding to the lower limit Pₘᵢₙ of the control range of the output power is lower than the upper limit fₘₐₓ of the control range of the voltage frequency. Therefore, the change amount of the output power with respect to a change in voltage frequency in the second type drooping characteristic becomes larger, and the output power Pₒᵤₜ₂ from the current source type distributed power supply 20-2 reaches the lower limit Pₘᵢₙ of the control range of the output power even when the voltage frequency is lower than the upper limit fₘₐₓ of the control range. Therefore, adjustment capability of the output power with respect to a fluctuation of a load by the current source type distributed power supply 20-2 is further exhibited, and a fluctuation of the voltage frequency is further suppressed.

In FIG. 8, as a relationship between output power and a voltage frequency, the second type drooping characteristic passing through all of (Pₘᵢₙ, Δfₘₐₓ₂), (P_{ref2}, 0), and (Pₘₐₓ, Δfₘᵢₙ₂) is indicated by a dotted broken line. In the configuration example illustrated in FIG. 6, the drooping characteristic determinator 112 only needs to set different values to the braking parameter D₂ of the current source type distributed power supply 20-2 depending on whether the output power Pₒᵤₜ₂ from the current source type distributed power supply 20-2 is equal to or more than the output power command value P_{ref2} as output power at the control point. When the output power Pₒᵤₜ₂ from the current source type distributed power supply 20-2 is equal to or more than the output power command value P_{ref2}, the drooping characteristic determinator 112 determines a value of the braking parameter D₂ of the current source type distributed power supply 20-2 as D_{2c}. D_{2c} represents a positive real number larger than D₂ₐ. When the output power Pₒᵤₜ₂ from the current source type distributed power supply 20-2 is less than the output power P_{ref2}, the drooping characteristic determinator 112 determines a value of the braking parameter D₂ of the current source type distributed power supply 20-2 as D_{2d}. D_{2d} represents a positive real number larger than D_{2c} and larger than D_{2b}.

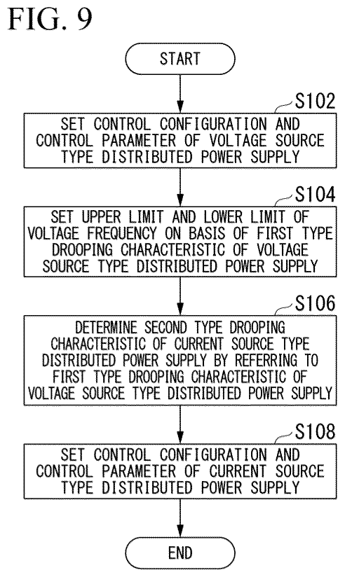

Next, an example of a drooping characteristic control flow according to the present disclosure will be described. FIG. 9 is a flowchart illustrating an example of the drooping characteristic control flow according to the present disclosure. In the example of FIG. 9, it is assumed that the output power command value P_{ref1} of the voltage source type distributed power supply 20-1 and the output power command value P_{ref2} of the current source type distributed power supply 20-2 are determined in advance.

(Step S102) The drooping characteristic determinator 112 determines control information indicating a control configuration and a control parameter for the voltage source type distributed power supply 20-1 on the basis of the output power command value P_{ref1} and the rated frequency fₙ. The control information is determined so as to obtain the first type drooping characteristic in which the voltage frequency f monotonically increases according to a decrease in output power Pₒᵤₜ₁ in a rated range of output power based on the output power command value P_{ref1}.

(Step S104) The drooping characteristic determinator 112 determines a lower limit and an upper limit of a control range of a voltage frequency respectively corresponding to a lower limit and an upper limit of a rated range of output power by referring to the first type drooping characteristic based on the determined control information.

(Step S106) The drooping characteristic determinator 112 determines the second type drooping characteristic that provides a control range of output power for a control range of a voltage frequency so as to include a rated range of output power based on the first type drooping characteristic.

(Step S108) The drooping characteristic determinator 112 determines control information indicating a control configuration and a control parameter for the current source type distributed power supply 20-2 that exhibits the determined second type drooping characteristic. The control information is determined such that the second type drooping characteristic is obtained in a control range of a voltage frequency in which the output power Pₒᵤₜ₂ for the rated frequency fₙ at the control point is determined as the output power command value P_{ref2} and which is based on the rated frequency fₙ.

Thereafter, the drooping characteristic determinator 112 outputs the control information determined for the voltage source type distributed power supply 20-1 and the control information determined for the current source type distributed power supply 20-2 to the voltage source type distributed power supply 20-1 and the current source type distributed power supply 20-2, respectively, using the control information setter 114. The control information input to each of the voltage source type distributed power supply 20-1 and the current source type distributed power supply 20-2 is used for controlling output power and a voltage frequency.

Note that when the output power command value of each distributed power supply is determined in advance, the control configuration and the control parameter for the voltage source type distributed power supply 20-1 may be determined in advance. In this case, the processing in step S102 and step S104 may be omitted. The control configuration may be fixed in advance for each distributed power supply. In this case, the drooping characteristic determinator 112 only needs to notify the distributed power supply 20 of the control information not including information of the control configuration.

In addition, the number of the distributed power supplies 20 may be three or more. One or both of the number of voltage source type distributed power supplies and the number of current source type distributed power supplies may be two or more.

As illustrated in Expression (1), the condition A of the control point of the distributed power supply 20 corresponds to that a voltage frequency f_{GFM,m} of each of the voltage source type distributed power supplies is equal to a voltage frequency f_{GFL,1} of each of the current source type distributed power supplies. In Expression (1), m is an index indicating each voltage source type distributed power supply. m is an integer of 1 or more and M or less. M represents the number of voltage source type distributed power supplies. 1 is an index indicating each current source type distributed power supply. 1 is an integer of 1 or more and L or less. L represents the number of current source type distributed power supplies.

$$\begin{matrix}[ Mathematical expression 1 ] & \\ {f}_{GFM , m} = {f}_{GFL , l} & ( 1 )\end{matrix}$$

As illustrated in Expression (2), the condition B of the control point of the distributed power supply 20 corresponds to that a sum of output power P_{out_GFM,m} from a voltage source type distributed power supply m and output power P_{out_GFL,1} from a current source type distributed power supply 1 is equal to total demand power P_{load}.

$$\begin{matrix}[ Mathematical expression 2 ] & \\ {\sum }_{m = 1}^{M} {P}_{out \_ GFM , m} + {\sum }_{l = 1}^{L} {P}_{out \_ GFL , l} = {P}_{load} & ( 2 )\end{matrix}$$

The drooping characteristic determinator 112 can determine output power satisfying the condition A and the condition B at the rated frequency fₙ as an output power command value for each of the distributed power supplies 20 by performing the above optimum calculation.

When the number M of voltage source type distributed power supplies is one and the number of current source type distributed power supplies is a plurality, the drooping characteristic determinator 112 can determine the second type drooping characteristic of each of the current source type distributed power supplies by referring to the first type drooping characteristic of the voltage source type distributed power supply. Also in this case, the drooping characteristic determinator 112 determines a control range of a voltage frequency on the basis of the first type drooping characteristic. The drooping characteristic determinator 112 determines the second type drooping characteristic of each of the current source type distributed power supplies such that a range of output power corresponding to a control range of a voltage frequency includes a control range of output power of the first type drooping characteristic. The drooping characteristic determinator 112 can determine control information of the corresponding current source type distributed power supply on the basis of the determined second type drooping characteristic.

When the number M of voltage source type distributed power supplies is two or more, the drooping characteristic determinator 112 may execute the following procedure to determine a control range of a voltage frequency common to the M voltage source type distributed power supplies and a control range of output power, and may determine the second type drooping characteristic of each current source type distributed power supply such that a control range of output power corresponding to the control range of the common voltage frequency includes the control range of the voltage frequency common to the M voltage source type distributed power supplies.

More specifically, as illustrated in steps S102 and S104, the drooping characteristic determinator 112 determines the first type drooping characteristic on the basis of the output power command value P_{ref_GFM,m} for each of the plurality of voltage source type distributed power supplies m. In the process, a value range from a lower limit f_{min,m} to an upper limit f_{max,m}, which is a control range of a voltage frequency, is determined so as to insert the rated frequency fₙ, and a value range from a lower limit P_{min,m} to an upper limit P_{max,m}, which is a rated range of output power, is determined so as to insert the output power command value P_{ref_GFM,m}.

Next, the drooping characteristic determinator 112 determines, as a control range of a voltage frequency for the current source type distributed power supply, a value range common to the plurality of voltage source type distributed power supplies m in the value range from the lower limit f_{min,m} to the upper limit f_{max,m}, which is a control range of a voltage frequency of each of the plurality of voltage source type distributed power supplies m. Here, the drooping characteristic determinator 112 selects, as a lower limit of the control range of the voltage frequency, a maximum value among the lower limits f_{min,m} of the voltage frequency for the voltage source type distributed power supplies m. Here, the drooping characteristic determinator 112 selects, as an upper limit of the control range of the voltage frequency, a minimum value among the upper limits f_{max,m} of the voltage frequency for the voltage source type distributed power supplies m.

The drooping characteristic determinator 112 determines, as a control range of output power of the current source type distributed power supply, a range including all value ranges from a lower limit P′_{min,m} to an upper limit P′_{max,m} of the control range of the output power for the control range of the common voltage frequency by referring to the first type drooping characteristic for the plurality of voltage source type distributed power supplies m. Here, the drooping characteristic determinator 112 selects, as a lower limit of the control range of the output power for the current source type distributed power supply, a minimum value among the lower limits P′_{min,m} of the control range of the output power for the voltage source type distributed power supplies m. The drooping characteristic determinator 112 selects, as an upper limit of the control range of the output power for the current source type distributed power supply, a maximum value among the upper limits P′_{max,m} of the control range of the output power for the voltage source type distributed power supplies m.

Therefore, the control range of the output power by the second type drooping characteristic includes a widest control range of the output power with respect to a narrowest rated range of the voltage frequency among the M voltage source type distributed power supplies. Therefore, adjustment capability of the output power of the current source type distributed power supply is utilized without being affected by a difference in power supply capability and operating state of each of the voltage source type distributed power supplies m.

Some or all of the plurality of distributed power supplies 20 may be variable in which of the voltage source type distributed power supply and the current source type distributed power supply is operated as the type of the distributed power supply. The type of the distributed power supply depends on a control configuration for an inverter power supply. The drooping characteristic determinator 112 may determine the type of a distributed power supply 20 whose type is variable (hereinafter, also referred to as a “variable distributed power supply”) on the basis of a fluctuation ratio of demand power. For example, the drooping characteristic determinator 112 decreases a ratio of the variable distributed power supply operated as the voltage source type distributed power supply and increases a ratio of the variable distributed power supply operated as the current source type distributed power supply as the fluctuation ratio is higher. The drooping characteristic determinator 112 notifies the variable distributed power supply of control information including information on the type of the distributed power supply that determines a drooping characteristic according to a method corresponding to the determined type using the control information setter 114.

When the type indicated in the control information input from the distributed power supply integrated management device 10 is the voltage source type distributed power supply, the variable distributed power supply starts a function as the voltage source type distributed power supply. Then, a computer system of the variable distributed power supply enables operations of the frequency controller 214 and the voltage controller 218, and disables operations of the power controller 234 and the current controller 238.

When the type indicated in the control information input from the distributed power supply integrated management device 10 is the current source type distributed power supply, the variable distributed power supply starts a function as the current source type distributed power supply. Then, a computer system of the variable distributed power supply disables operations of the frequency controller 214 and the voltage controller 218, and enables operations of the power controller 234 and the current controller 238.

Note that, in the distributed power supply integrated management system S1, at least one (for example, the voltage source type distributed power supply 20-1) of the plurality of distributed power supplies 20 may include the drooping characteristic determinator 252 and the control information setter 254 and may have a distributed power supply management function (not illustrated). The drooping characteristic determinator 252 and the control information setter 254 execute processing similar to those of the drooping characteristic determinator 112 and the control information setter 114, respectively. Note that the control information setter 254 outputs control information for the power supply of the control information setter 254 to the drooping characteristic determinator 252, and outputs control information for another power supply to the power supply. A distributed power supply 20 having a distributed power supply management function may further include an output power command value determinator 256 and a storage 260 (not illustrated). The storage 260 stores data similar to that of the storage 120, and the output power command value determinator 256 executes processing similar to that of the output power command value determinator 116.

When the distributed power supply integrated management system S1 includes the distributed power supply 20 having the distributed power supply management function, the distributed power supply integrated management device 10 may be omitted.

Note that some units or all units of the distributed power supply integrated management device 10, for example, the drooping characteristic determinator 112, the control information setter 114, and the output power command value determinator 116, and some units or all units of the distributed power supply 20, for example, the frequency controller 214, the voltage controller 218, the power controller 234, and the current controller 238 may be implemented using a dedicated integrated circuit such as a field-programmable gate array (FPGA) or an application specific integrated circuit (ASIC), or may be implemented using a general-purpose computer system. The computer system includes a processor and a storage medium. The processor executes a predetermined program to implement a function of each functional unit in cooperation with the storage medium and other hardware. In the present application, “execution of a program” or “executing a program” includes executing processing instructed by a command described in a program. The processor is, for example, a central processing unit (CPU). The storage medium includes, for example, a random access memory (RAM) and a read-only memory (ROM). Various types of data are temporarily or non-temporarily stored in the storage medium. The stored data can include a program and a parameter set used for execution of the program. The program may be configured in any form such as an application program, a utility, firmware, or an application programming interface (API) function. In addition, the program may be configured as a differential program for implementing a part of a main target function.

As described above, the distributed power supply integrated management system S1 according to the present embodiment manages the plurality of distributed power supplies 20, and the plurality of distributed power supplies 20 at least includes one voltage source type distributed power supply 20-1 and one current source type distributed power supply 20-2. The voltage source type distributed power supply 20-1 operates as a voltage source and has the first type drooping characteristic that is a drooping characteristic in which a voltage frequency changes according to output power, and the current source type distributed power supply 20-2 operates as a current source and has the second type drooping characteristic that is a drooping characteristic in which output power changes according to a voltage frequency. The distributed power supply integrated management system S1 includes the drooping characteristic determinator 112 that determines control information that provides the second type drooping characteristic on the basis of the first type drooping characteristic in a control range of a common voltage frequency, and the control information setter 114 that sets the determined control information in the current source type distributed power supply 20-2.

In addition, at least one of the plurality of distributed power supplies 20 may include a storage battery. The drooping characteristic determinator 112 may determine a rated output value in a discharge direction of the storage battery as an upper limit (for example, Pₘₐₓ) of a control range of output power, and may determine a rated output value in a charge direction of the storage battery as a lower limit (for example, Pₘᵢₙ) of the control range of the output power.

With this configuration, control information that provides the second type drooping characteristic determined by referring to the first type drooping characteristic of the voltage source type distributed power supply 20-1 is set in the current source type distributed power supply 20-2. Therefore, the output power of the voltage source type distributed power supply 20-1 and the current source type distributed power supply 20-2 is controlled while a voltage frequency is synchronized according to a fluctuation of demand power. Therefore, adjustment capability of the output power by the current source type distributed power supply 20-2 is further exhibited than that in a case where the control information of the voltage source type distributed power supply 20-1 and the control information of the current source type distributed power supply 20-2 are independently determined.

In addition, the drooping characteristic determinator 112 may determine a control range (for example, from the voltage frequency deviation Δfₘᵢₙ to the voltage frequency deviation Δfₘₐₓ) of a voltage frequency corresponding to a control range (for example, from Pₘᵢₙ to Pₘₐₓ) of output power of the voltage source type distributed power supply 20-1 on the basis of the first type drooping characteristic, and may determine the second type drooping characteristic such that a control range of output power of the current source type distributed power supply 20-2 with respect to a control range (for example, from the voltage frequency deviation Δfₘᵢₙ to the voltage frequency deviation Δfₘₐₓ) of a voltage frequency based on the second type drooping characteristic includes a rated range of the output power of the voltage source type distributed power supply 20-1.

With this configuration, in the control range of the common voltage frequency, the control range of the output power of the current source type distributed power supply 20-2 can cover the rated range of the output power of the voltage source type distributed power supply 20-1. The current source type distributed power supply 20-2 can share a fluctuation of the output power with the voltage source type distributed power supply 20-1 according to a fluctuation of demand power without being limited to the control range. Therefore, the adjustment capability of the output power by the current source type distributed power supply 20-2 is exhibited.

The drooping characteristic determinator 112 may determine the second type drooping characteristic such that output power monotonously increases as a voltage frequency decreases, and a voltage frequency (for example, the voltage frequency deviation Δfₘᵢₙ₂) corresponding to an upper limit (for example, Pₘₐₓ) of the control range of the output power of the current source type distributed power supply 20-2 is equal to or more than a lower limit (for example, the voltage frequency deviation Δfₘᵢₙ) of the control range of the voltage frequency of the voltage source type distributed power supply 20-1.

With this configuration, at a voltage frequency at which a lower limit of the control range of the voltage frequency is equal to or less than a lower limit of the control range of the voltage frequency of the voltage source type distributed power supply 20-1, the output power of the current source type distributed power supply 20-2 reaches an upper limit of the control range. Therefore, adjustment capability of the output power by the current source type distributed power supply 20-2 is exhibited at a voltage frequency lower than the rated voltage frequency. As a result, a fluctuation of the voltage frequency is suppressed.

The drooping characteristic determinator 112 may determine the second type drooping characteristic such that output power monotonously decreases as a voltage frequency increases, and a voltage frequency (for example, the voltage frequency deviation Δfₘₐₓ₂) corresponding to a lower limit (for example, Pₘᵢₙ) of the control range of the output power of the current source type distributed power supply 20-2 is equal to or less than an upper limit (for example, the voltage frequency deviation Δfₘₐₓ) of the control range of the voltage frequency of the voltage source type distributed power supply 20-1.

With this configuration, at a voltage frequency at which an upper limit of the control range of the voltage frequency is equal to or less than an upper limit of the control range of the voltage frequency of the voltage source type distributed power supply 20-1, the output power of the current source type distributed power supply 20-2 reaches a lower limit of the control range. Therefore, adjustment capability of the output power by the current source type distributed power supply 20-2 is exhibited at a voltage frequency higher than the rated voltage frequency. As a result, a fluctuation of the voltage frequency is suppressed.

In addition, the plurality of distributed power supplies 20 may include a plurality of (for example, M) voltage source type distributed power supplies, and the drooping characteristic determinator 112 may determine control information of a current source type distributed power supply such that a control range (for example, from the voltage frequency deviation Δfₘᵢₙ₂ to the voltage frequency deviation Δfₘₐₓ₂) of a voltage frequency of the current source type distributed power supply with respect to a control range (for example, from Pₘᵢₙ₂ to Pₘₐₓ₂) of output power based on the second type drooping characteristic is included in all of control ranges (for example, from f_{min,m} to f_{max,m}) of a voltage frequency with respect to a rated range (for example, from P_{min,m} to P_{max,m}) of output power of the voltage source type distributed power supply m based on the first type drooping characteristic of each of the plurality of voltage source type distributed power supplies, and a control range (for example, from Pₘᵢₙ₂ to Pₘₐₓ₂) of output power based on the second type drooping characteristic includes all of control ranges (for example, from P′_{min,m} to P′_{max,m}) of a voltage frequency with respect to a control range (for example, from the voltage frequency deviation Δfₘᵢₙ₂ to the voltage frequency deviation Δfₘₐₓ₂) of a voltage frequency of the current source type distributed power supply based on the first type drooping characteristic of each of the plurality of voltage source type distributed power supplies.

Therefore, the control range of the output power by the second type drooping characteristic includes an output range that is equal to or larger than a widest control range of output power with respect to a narrowest rated range of a voltage frequency among the plurality of voltage source type distributed power supplies. Therefore, adjustment capability of the output power of the current source type distributed power supply is utilized without being affected by a difference in power supply capability and operating state of each of the voltage source type distributed power supplies.

In addition, the distributed power supply integrated management system S1 may include the output power command value determinator 116 that determines an output power command value such that a total value of output power command values of the plurality of distributed power supplies 20 is equal to or less than demand power and the output power command values of the plurality of distributed power supplies 20 are within respective ranges of outputtable power. The drooping characteristic determinator 112 may update a control range (for example, from Pₘᵢₙ to Pₘₐₓ) of output power on the basis of an output power command value for the voltage source type distributed power supply 20-1.

With this configuration, the output power of the voltage source type distributed power supply and the current source type distributed power supply is controlled while a voltage frequency is synchronized according to a fluctuation of demand power. Therefore, adjustment capability of output power of the current source type distributed power supply can be exhibited.

Although the embodiment of the present disclosure has been described above, the present disclosure is not limited to the embodiment and modifications thereof. Addition, omission, substitution, and other changes of the configuration can be made without departing from the gist of the present disclosure.

The directions of an arrow illustrated in block diagrams and other drawings are for convenience of description, and do not limit a flow direction of information, data, signals, and the like in implementation.

In addition, the present disclosure is not limited by the above description, but is limited only by the appended claims.

### INDUSTRIAL APPLICABILITY

According to the distributed power supply integrated management system, the distributed power supply integrated management device, the distributed power supply integrated management method, and the program according to the present disclosure, control information of a current source type distributed power supply is determined on the basis of a first type drooping characteristic of a voltage source type distributed power supply in a control range of a common voltage frequency. Therefore, in a self-sustaining power system, adjustment capability of the output power of the current source type distributed power supply can be exhibited

### REFERENCE SIGNS LIST

S1 Distributed power supply integrated management system
10 Distributed power supply integrated management device
20 Distributed power supply
20-1 Voltage source type distributed power supply
20-2 Current source type distributed power supply
112 Drooping characteristic determinator
114 Control information setter
116 Output power command value determinator
120 Storage
212 Inputter/outputter
214 Frequency controller
214a, 214b, 214c Subtractor
214d Integrator
214e Multiplier
214f Speed governor
214g Adder
218 Voltage controller
222 Voltage source inverter
232 Inputter/outputter
234 Power controller
234a Subtractor
234b Multiplier
234c Differentiator
234d Multiplier
234e, 234f Adder
238 Current controller
242 Current source inverter

1. A distributed power supply integrated management system that manages a plurality of distributed power supplies, wherein
the plurality of distributed power supplies at least includes one voltage source type distributed power supply and one current source type distributed power supply,
the voltage source type distributed power supply operates as a voltage source and has a first type drooping characteristic that is a drooping characteristic in which a voltage frequency changes according to output power,
the current source type distributed power supply operates as a current source and has a second type drooping characteristic that is a drooping characteristic in which output power changes according to a voltage frequency, and
the distributed power supply integrated management system comprises:
a drooping characteristic determinator that determines control information that provides the second type drooping characteristic on a basis of the first type drooping characteristic in a control range of a common voltage frequency; and
a control information setter that sets the control information in the current source type distributed power supply.

2. The distributed power supply integrated management system according to claim 1, wherein
the drooping characteristic determinator
determines a control range of the voltage frequency corresponding to a control range of output power of the voltage source type distributed power supply on a basis of the first type drooping characteristic, and
determines the second type drooping characteristic such that a control range of output power of the current source type distributed power supply with respect to a control range of the voltage frequency based on the second type drooping characteristic includes the control range of the output power of the voltage source type distributed power supply.

3. The distributed power supply integrated management system according to claim 2, wherein
the drooping characteristic determinator determines the second type drooping characteristic such that
output power monotonously increases as the voltage frequency decreases, and
a voltage frequency corresponding to an upper limit of the control range of the output power of the current source type distributed power supply is equal to or more than a lower limit of a control range of the voltage frequency of the voltage source type distributed power supply.

4. The distributed power supply integrated management system according to claim 2, wherein
the drooping characteristic determinator determines the second type drooping characteristic such that
output power monotonously decreases as the voltage frequency increases, and
a voltage frequency corresponding to a lower limit of the control range of the output power of the current source type distributed power supply is equal to or less than an upper limit of a control range of the voltage frequency of the voltage source type distributed power supply.

5. The distributed power supply integrated management system according to claim 2, wherein
the plurality of distributed power supplies include a plurality of voltage source-type distributed power supplies, and
the drooping characteristic determinator
determines control information of the current source type distributed power supply such that
a control range of a voltage frequency of the current source type distributed power source with respect to a control range of output power based on the second type drooping characteristic is included in all of control ranges of a voltage frequency with respect to a rated range of output power of the voltage source type distributed power supply based on the first type drooping characteristic of each of the plurality of voltage source type distributed power supplies, and
a control range of output power based on the second type drooping characteristic includes all of control ranges of a voltage frequency with respect to a control range of a voltage frequency of the current source type distributed power supply based on the first type drooping characteristic of each of the plurality of voltage source type distributed power supplies.

6. The distributed power supply integrated management system according to claim 1, comprising an output power command value determinator that determines an output power command value such that
a total value of the output power command values of the plurality of distributed power supplies is equal to or less than demand power, and
the output power command values of the plurality of distributed power supplies are within respective ranges of outputtable power, wherein
the drooping characteristic determinator
updates a control range of the output power on a basis of the output power command value for the voltage source type distributed power supply.

7. The distributed power supply integrated management system according to claim 1, wherein
at least one of the plurality of distributed power supplies includes a storage battery, and
the drooping characteristic determinator
determines a rated output value in a discharge direction of the storage battery as an upper limit of a control range of the output power, and
determines a rated output value in a charge direction of the storage battery as a lower limit of the control range of the output power.

8. A distributed power supply integrated management device that manages a plurality of distributed power supplies, wherein
the plurality of distributed power supplies at least includes one voltage source type distributed power supply and one current source type distributed power supply,
the voltage source type distributed power supply operates as a voltage source and has a first type drooping characteristic that is a drooping characteristic in which a voltage frequency changes according to output power,
the current source type distributed power supply operates as a current source and has a second type drooping characteristic that is a drooping characteristic in which output power changes according to a voltage frequency, and
the distributed power supply integrated management device comprises:
a drooping characteristic determinator that determines control information that provides the second type drooping characteristic on a basis of the first type drooping characteristic in a control range of a common voltage frequency; and
a control information setter that sets the control information in the current source type distributed power supply.

9. A computer readable non-transitory storage medium storing a program causing a processor to implement managing a plurality of distributed power supplies at least including one voltage source type distributed power supply and one current source type distributed power supply, wherein
the voltage source type distributed power supply operates as a voltage source and has a first type drooping characteristic that is a drooping characteristic in which a voltage frequency changes according to output power,
the current source type distributed power supply operates as a current source and has a second type drooping characteristic that is a drooping characteristic in which output power changes according to a voltage frequency, and
the program is a program for causing the processor to implement:
determining control information that provides the second type drooping characteristic on a basis of the first type drooping characteristic in a control range of a common voltage frequency, and
setting the control information in the current source type distributed power supply.

10. A distributed power supply integrated management method in a distributed power supply integrated management system that manages a plurality of distributed power supplies, wherein
the plurality of distributed power supplies at least includes one voltage source type distributed power supply and one current source type distributed power supply,
the voltage source type distributed power supply operates as a voltage source and has a first type drooping characteristic that is a drooping characteristic in which a voltage frequency changes according to output power,
the current source type distributed power supply operates as a current source and has a second type drooping characteristic that is a drooping characteristic in which output power changes according to a voltage frequency,
the method comprising:
determining, by a drooping characteristic determinator, control information that provides the second type drooping characteristic on a basis of the first type drooping characteristic in a control range of a common voltage frequency, and
setting, by a control information setter, the control information in the current source type distributed power supply.
